(19) United States
(12) Patent Application Publication
(10) Pub. No.: US 2016/0185459 A1
(43) Pub. Date: Jun. 30, 2016

(54) Auxiliary Device for High-Flying Aircraft

(71) Applicants: ASTRIUM GMBH, Taufkirchen (DE); EADS DEUTSCHLAND GMBH, Ottobrunn (DE)

(72) Inventors: Andreas KIEFER, Holzkirchen (DE); Jens FEDERHEN, Muenchen (DE); Dieter DRAGON, Aichach (DE); Werner SCHOLZ, Ohmden (DE)

(21) Appl. No.: 14/654,181

(22) PCT Filed: Dec. 18, 2013
(86) PCT No.: PCT/DE2013/000799

§ 371 Date: Jun. 19, 2015

(30) Foreign Application Priority Data
Dec. 20, 2012 (DE) 10 2012 025 026.6

(51) Int. Cl. B64D 27/26; B64D 5/00; B64D 27/24; B64D 41/00

(52) U.S. Cl. CPC B64D 27/26; B64D 41/00; B64D 5/00; B64D 27/24

(57) ABSTRACT

An auxiliary device is provided for a high-altitude airplane. The auxiliary device includes a drive, which is independent of the airplane, for the ascent of the airplane into the stratosphere. The airplane is releasably coupled to the auxiliary device. The auxiliary drive is releasable from the airplane altitude on the latest on reaching a predetermined mission.

### BACKGROUND AND SUMMARY OF THE INVENTION

The invention relates to an auxiliary device for a high-altitude airplane, in particular for a so-called stratosphere platform, also known as a high-altitude platform system (HAPS). Such vehicles rise up into the stratosphere, where they perform tasks like satellites for a long period of time in comparison with a conventional airplane. A “long period of time” is understood to be several weeks to months or even years. The stratosphere is the second layer of the earth's atmosphere, as seen from the ground. It begins at an altitude between approximately 8 kilometers at the geographic poles and approximately 18 km at the equator and extends to an altitude of approximately 50 km. A typical height of flight for a stratosphere platform is 20 km. The tests performed by such aircraft extend to observation of earth or communication functions, for example.

Such high-altitude airplanes are frequently driven by solar power, wherein a battery of the airplane is charged during the day with the help of solar cells and is discharged at night for operation of the airplane. This type of drive currently sets strict limits with regard to the available electric power and thus also the allowed weight of the airplane. In designing such airplanes, therefore, the lowest possible total weight and the best possible efficiency are desired.

The ascent of the airplane into the stratosphere makes special demands of the construction of the airplane. The greatest mechanical loads on the airplane occur during this phase. In addition, the greatest engine power is needed for this ascent.

The object of the present invention is to structurally and/or functionally optimize the operation of a high-altitude airplane both during its ascent into the stratosphere and during its operation in the stratosphere.

This object is achieved by an auxiliary device according to embodiments of the invention.

The invention creates an auxiliary device for a high-altitude airplane, comprising a drive, which is independent of the vehicle for the ascent of the airplane, which is detachably connected to the auxiliary device, into the stratosphere and can be released from the airplane on reaching a predetermined mission altitude at the latest.

This proposal is based on the consideration that in the case of a traditional high-altitude airplane, which performs the ascent into the atmosphere by utilizing its own airplane drive, the airplane carries more weight than necessary during the very long duration of the mission (several weeks or even months) in comparison with the duration of the ascent (a few hours), and the airplane drive is over-dimensioned for the actual mission. Due to the proposed auxiliary device, this problem can be bypassed in that the auxiliary device is detachably connected to the airplane prior to the start of the airplane and is separated from the airplane again at a predefined altitude. The auxiliary device is thus carried “piggyback” with the airplane.

This design of the airplane can be optimally adapted to the intended purpose in the stratosphere. In particular the airplane drive of the airplane need only be adapted to operation in the stratosphere. The airplane can be optimized in this way not only with regard to weight but instead the drive, which is much smaller by comparison, may also be provided in a much less expensive form.

The auxiliary device may optionally be arranged on and/or beneath the airplane or at the sides thereof. An arrangement beneath the airplane is preferred because after the auxiliary device has been released from the airplane, it can be separated from the high-altitude airplane based only on the force of gravity.

In one embodiment, the drive of the auxiliary device may be of a non-electric type. In particular, the drive may be an internal combustion engine, in which case a fuel, which is required for operation, is stored, i.e., contained, in a reservoir in the auxiliary device. In an alternative embodiment, the drive may also comprise an electric motor, which supplies electricity to the auxiliary device from an energy storage mechanism. The energy storage device may optionally be a battery or a rechargeable battery.

In another embodiment, a stabilizer for stabilizing the ascent into the atmosphere may be provided on the auxiliary device. In particular, such a stabilizer may comprise one or more controllable wings and/or a controllable auxiliary drive and/or a direction-changing system (in the sense of a steering) for the drive. The stabilizer not only ensures additional stability with regard to the flight altitude but can also absorb special mechanical loads in the ascent of the airplane into the stratosphere and can thus keep them away from the airplane.

According to another advantageous embodiment, the auxiliary device is designed to be reusable and has means to allow a return to earth independently of the airplane. Such means may include, for example, an uncontrolled parachute, a controlled paraglider or controllable wings. For example, the auxiliary device may be designed in the form of an airplane, so that it can return to earth by sailing and/or with additional use of the drive force of its drive after being separated from the airplane. This permits multiple use of the auxiliary device.

In another embodiment, the releasable coupling to the airplane is accomplished by way of a coupling device arranged on the auxiliary device and/or on the airplane. The releasable coupling may be of a mechanical, electromechanical or electromagnetic type, but combinations of the aforementioned variants are also possible.

To be able to accomplish the ascent of the high-altitude airplane into the atmosphere by use of the auxiliary device, the drive of the auxiliary device has a greater power than an airplane drive of the airplane, which is preferably solar electric. In particular, the drive may be designed so that, by sole operation thereof, the ascent into the stratosphere is made possible by the auxiliary device and the airplane coupled to it. However, the drive of the auxiliary device may also be of such a size that it is of such dimensions that its drive, together with the airplane drive of the airplane, supply the required power for the ascent into the stratosphere. In particular the drive of the auxiliary device has a power adapted to the ascent to the predetermined altitude.

### BRIEF DESCRIPTION OF THE DRAWINGS

The invention is explained in greater detail below on the basis of one exemplary embodiment in the drawings, in which:

FIG. 1 shows an auxiliary device according to an embodiment of the invention, which is mounted on a high-altitude airplane, and

FIG. 2 shows a schematic diagram of the auxiliary device, which has just been separated from the airplane after reaching a predefined mission altitude.

### DETAILED DESCRIPTION OF THE DRAWINGS

The exemplary embodiment of an auxiliary device 20 according to the invention for a high-altitude airplane 10, as described below, is based on the consideration that more power is needed during the ascent of a high-altitude airplane than after reaching a predetermined mission altitude in the stratosphere during the actual mission. During the ascent, a larger and heavier drive would be needed with a traditional airplane than during the actual mission. As a result, the drive is to be regarded in part as unnecessary dead weight during the mission. In addition, the drive cannot be operated in the range of its best efficiency. This is even more problematical since the duration of a mission of an airplane is very long in comparison with the ascent. The duration of the mission may readily amount to several months while the ascent into the stratosphere is possible in a few hours.

The basic principle of the present invention consists of using an auxiliary device 20 with its own drive 21 during the ascent of the airplane 10, this auxiliary device then being separated from the airplane 10 on reaching the predetermined mission altitude or any other suitable point in time and returning to the ground.

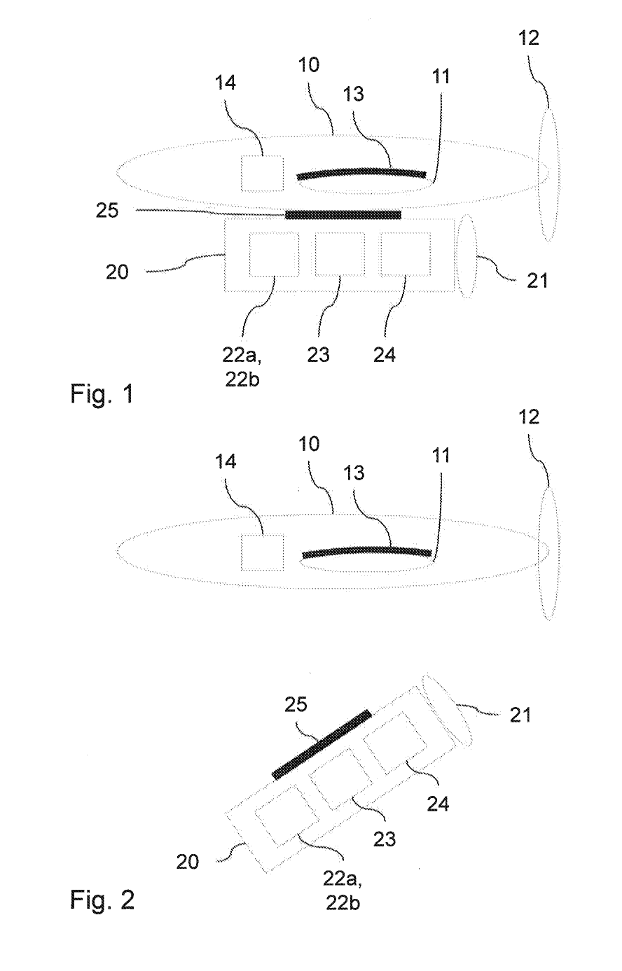

FIG. 1 shows in a schematic diagram an auxiliary device 20, which is detachably coupled to a high-altitude airplane 10 by way of a coupling device 25.

The airplane 10 comprises a solar electric drive 12 (hereinafter also referred to as an airplane drive), which can optionally be supplied by solar cells 13 or from an energy storage mechanism 14 of the airplane 10. Merely as an example, the solar cells 13 are arranged on wings 11 of the airplane 10, which has been diagrammed schematically. The airplane comprises additional means, not shown, for fulfilling tasks for observation of earth and/or telecommunication and the like. The solar electric drive 12 is designed to ensure the operation of the airplane 10 over the intended period of time (mission duration) only at a predetermined mission altitude, i.e., at an altitude between 15 and 25 km. The airplane drive can be optimized for this intended purpose. The drive power of the solar electric drive 12 alone would therefore also not be sufficient to convey the airplane 10 from the ground to the predefined mission altitude.

This object is fulfilled by the auxiliary device 20. This auxiliary device has a separate drive 21, which has a power that can convey the auxiliary device 20 together with the airplane 10 to the predefined mission altitude. The auxiliary device 20 can be released from the airplane 10 by appropriate actuation of the coupling device 25 at the latest on reaching the predetermined mission altitude or at another suitable point in time so that the auxiliary device moves in the direction of the earth by the force of gravity as shown in FIG. 2.

The drive 21 of the auxiliary device 10 may be designed as a non-electric drive, for example. Internal combustion engines in particular may be considered, wherein a fuel, which is required for operation, is stored in a reservoir 22a of the auxiliary device. Likewise, the drive may also be designed as an electric drive. In this case, instead of the fuel reservoir 22a, an energy storage mechanism 22b in the form of a battery or a rechargeable battery may be provided in the auxiliary device 20.

Various alternatives are possible for safe and/or controlled return of the auxiliary device 20 to the ground. In the simplest case, destruction of the auxiliary device 20 is prevented by a simple uncontrolled parachute. Controlled paragliders may also be used for a safe landing of the auxiliary device 20. Another variant would consist of designing the auxiliary device 20 in the form of a small airplane, so that it could return to the ground independently of the airplane by using its own drive 21 and/or by gliding. It is then also possible to control the auxiliary device. A corresponding return device is indicated with the reference numeral 24 in the diagrams.

Reference numeral 23 characterizes a stabilizer which stabilizes the flight altitude of the auxiliary device 20 and of the airplane 10 in their ascent into the stratosphere. There may be in particular one or more controllable wings and/or a controllable auxiliary drive and/or a direction-changing system for the drive 21. The stabilizer 23 ensure additional stability with respect to special mechanical loads during the ascent into the stratosphere. Peak loads acting on the airplane 10 during the ascent into the stratosphere can be prevented in this way.

Use of the proposed auxiliary device, which flies along “piggyback” beneath or optionally also on top of the airplane 10, permits weight savings with airplane 10. In addition, the airplane 10 may also be designed with regard to the mission to be carried out. A design from the standpoint of the ascent phase is not necessary. In particular, the airplane drive 12 may be of such dimensions that it can be operated with optimal efficiency during its mission.

In contrast with an arrangement in which the airplane is arranged releasably on a carrier plane or some other aircraft (blimp, weather balloon), the proposed concept can be implemented with less effort and lower cost.

In the present description, an airplane has been described as representative of a stratosphere platform. The term “airplane” is to be interpreted broadly. In particular the airplane need not necessarily have the typical shape of an airplane. The design may instead be of any type, so that it is suitable for fulfilling the task imposed upon it in the stratosphere.

### LIST OF REFERENCE NUMERALS

10 airplane (10)
11 wing
12 airplane drive
13 solar cell
14 energy storage device
20 auxiliary device
21 drive
22a energy storage device
22b fuel reservoir
23 stabilizer
24 return device
25 coupling device

1-10. (canceled)

11. An auxiliary device for a high-altitude airplane, comprising:
a drive operatively configured for an ascent of the airplane into the stratosphere, the drive being independent of the airplane, wherein
the auxiliary device is configured to be releasably coupled to the high-altitude airplane so as to be releasable at latest upon reaching a predetermined mission altitude of the high-altitude airplane.

12. The auxiliary device according to claim 11, wherein the auxiliary device is configured to be arranged on the airplane.

13. The auxiliary device according to claim 11, wherein the auxiliary device is configured to be arranged beneath the airplane.

14. The auxiliary device according to claim 11, further comprising:
a fuel reservoir of the auxiliary device, wherein
the drive is a non-electric drive, wherein fuel required for operation of the non-electric drive is stored in the reservoir.

15. The auxiliary device according to claim 14, wherein the drive is an internal combustion engine.

16. The auxiliary device according to claim 11, wherein the drive comprises an electric motor, the electric motor being supplied with energy from an energy storage mechanism of the auxiliary device.

17. The auxiliary device according to claim 11, further comprising:
a stabilizer of the auxiliary device, the stabilizer being configured to stabilize a flight position in the ascent into the stratosphere.

18. The auxiliary device according to claim 17, wherein the stabilizer is at least one of a controllable wing, a controllable auxiliary drive, or a direction-changing device for the drive.

19. The auxiliary device according to claim 11, wherein the auxiliary device is configured to be reusable.

20. The auxiliary device according to claim 11, further comprising:
an uncontrolled parachute of the auxiliary device.

21. The auxiliary device according to claim 11, further comprising:
a controlled parasail or a controllable wing of the auxiliary device.

22. The auxiliary device according to claim 11, further comprising:
a coupling device arrangeable on the auxiliary device or on the airplane, the coupling device being configured to carry out the releasable coupling of the auxiliary device with the high-altitude airplane.

23. The auxiliary device according to claim 11, wherein the drive has a higher power than a solar electric drive of the airplane.

24. The auxiliary device according to claim 23, wherein the drive is configured to have a power adapted to the ascent of the airplane to the predetermined mission altitude.
